(19) United States
(12) Patent Application Publication
(10) Pub. No.: US 2005/0119839 A1
(43) Pub. Date: Jun. 2, 2005

(54) Flow irreversibility measurement system

(76) Inventors: Gregory F Naterer, Winnipeg (CA); Olusola B. Adeyinka, Winnipeg (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/505,688

(22) PCT Filed: Feb. 26, 2003
(86) PCT No.: PCT/CA03/00262

Related U.S. Application Data
(60) Provisional application No. 60/359,455, filed on Feb. 26, 2002.

(51) Int. Cl. G01N 11/00

(52) U.S. Cl. 702/50

(57) ABSTRACT

A detector for detecting fluid flow irreversibility is disclosed herein. The detector uses a spatial velocity field to determine the entropy production distribution of the flow, and generates a loss coefficient distribution on the basis the determined entropy distribution.

### FIELD OF THE INVENTION

The present invention relates generally to energy characterization, design optimization and candidate selection tools and methods. More particularly, the present invention relates to a system and method for determining fluid flow irreversibility through the determination of an entropy field.

### BACKGROUND OF THE INVENTION

In many design fields aerodynamic properties of a structure are essential to determining the feasibility and efficiency of the design. To quantify the inefficiencies in various systems, an entropy value for a system can be generated based on measured overall efficiency.

The source of entropy in fluid flows is flow irreversibilities. A flow irreversibility in, or around, a structure creates turbulence that adversely impacts upon efficiency. For example, the measurement of flow patterns and turbulence around road vehicles, trains and aircraft has long been used to assess their aerodynamic efficiency and to optimize design. The optimal design for such a structure is one that allows a smooth air flow profile, so that drag is reduced and the power of the engine is directed towards propulsion, as opposed to being directed to overcoming the internal inefficiency.

Such investigations are also performed on the design of buildings, wind turbines, space vehicles and bridges. The benefits derived from aerodynamic optimisation include reduced fuel consumption, greater stability, lower noise levels and increased comfort. Local irreversibilities in fluid flows (such as fluid friction in mixing processes) are known to represent a primary cause of reduced system efficiency. The entropy produced in fluid flow leads to pressure losses or other irreversible degradation of mechanical energy into internal energy. With current technologies, this loss of useful energy can only be detected on a global scale, typically through a single loss coefficient, called K (i.e. pressure measurements at the inlet and outlet of a valve). To calculate the entropy of a system, a set of input parameters are compared to a set of output parameters to determine an entropy value for the overall system. As entropy values are indicative of the overall efficiency of a design, they can be used as a design criteria. At present there is no simple and effective methodology for determining the local entropy of a region of a structure or design. Unlike either the velocity or temperature of a fluid there is no direct way of measuring entropy.

However, a variety of systems can be used to determine the velocity of fluid flow around, or inside of, a structure. One such line of systems are Particle Image Velocimetry (PIV) systems produced by Dantec Dynamics, and are used both in wind tunnels and in situ. The present uses of these systems range from basic research in fluid mechanics to advanced use in product engineering where the aim is to optimise internal and/or external flow behaviour.

Other fluid flow velocity detectors include Laser Doppler scanners. Field flow structure can be interpolated using commonly known numerical methods and computational techniques.

If either a direct entropy measurement, or a simple technique for local entropy calculation, existed it would serve as a standard way of identifying any device's energy wastefulness and allow design of components and structures to reduce the entropy generated in selected subcomponents. It is, therefore, desirable to provide a method and system for determining the entropy field of a structure or design.

### SUMMARY OF THE INVENTION

It is an object of the present invention to obviate or mitigate at least one disadvantage of previous flow irreversibility detection systems.

In a first aspect of the present invention, there is provided a method of detecting flow irreversibility in a fluid flow having a predetermined spatial velocity field representing the spatial distribution of velocities in a fluid flow. The method comprises determining and entropy production rate, generating a spatial distribution of a loss coefficient, and analysing the spatial distribution of the loss coefficient to identify a flow irreversibility. The local entropy production rate represents the spatial distribution of entropy production in the fluid flow, and is determined in accordance with incremental spatial velocities determined from the spatial velocity field and a ratio of viscosity and temperature profiles of the fluid flow. The spatial distribution of a loss coefficient, represents the spatial distribution of inefficiencies arising from flow irreversibility in the fluid flow, and is generated in accordance with the temperature profile and the determined entropy production rate.

In an embodiment of the first aspect of the present invention, the spatial velocity field is a set of discrete values, and the resulting entropy production rate and spatial distribution of the loss coefficient are discrete valued functions, and the resulting entropy production rate relates fluid viscosity, velocity of the fluid in each of two directions, temperature of the fluid, and spacing of grid elements in one of the spatial velocity field, the fluid viscosity profile and the temperature profile. In another embodiment of the first aspect of the present invention, the viscosity profile and the temperature profile are constant valued. In a further embodiment of the first aspect of the present invention the step of generating the spatial distribution of the loss coefficient further includes determining a head loss value and determining a local loss coefficient. The head loss value relates the temperature profile, mass flow in the fluid flow and the entropy production rate, and represents local friction loss. The local loss coefficient relates the head loss value, total velocity of the fluid and acceleration due to gravity, the local loss co-efficient and represents the loss coefficient in a defined region of the fluid flow.

In a second aspect of the present invention, there is provided a flow irreversibility detector. The detector is for detecting a flow irreversibility in a fluid flow that has a predetermined spatial velocity field representing spatial distribution of velocities in the fluid flow and comprises an entropy contour generator, a loss coefficient distribution generator and an irreversibility identifier. The entropy contour generator is for receiving the spatial velocity field, and for generating an entropy production contour representing adjoining regions with similar entropy production rates in accordance with a ratio of a fluid viscosity profile and a fluid temperature profile and the incremental spatial velocities from the predetermined spatial velocity field. The loss coefficient distribution generator is for receiving from the entropy contour generator the entropy production contour and for generating a spatial distribution of a loss coefficient representing the spatial distribution of inefficiencies arising from flow irreversibility in the fluid flow, in accordance with the temperature profile and the entropy contour. The irreversibility identifier is for detecting regions of flow irreversibility by analysing the spatial distribution of the loss coefficient.

In an embodiment of the second aspect of the present invention, the spatial velocity field is generated by a particle image velocimetry system. Another embodiment of the second aspect of the present invention further includes a design analyser for modifying a design of a structure to reduce the loss coefficient in detected regions of flow irreversibility. In a further embodiment of the second aspect of the present invention, the spatial velocity field is generated by a design modelling tool for simulating fluid flow in a design, and the detector further includes a design analyser for modifying the design to reduce the loss coefficient in detected regions of flow irreversibility.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flow chart illustrating a method of the present invention;

FIG. 2 is a system of the present invention; and

FIG. 3 is an alternate embodiment of the system of the present invention.

### DETAILED DESCRIPTION

Generally, the present invention provides a system and method for detecting fluid flow irreversibilities through the calculation of an entropy production rate for the fluid flow.

To reduce design time, it is common to evaluate prototypes of a design with a fluid flow testing apparatus. Though the following description is based on the use of a PIV testing apparatus, one skilled in the art will appreciate that other fluid flow testing equipments, such as Laser Doppler testing equipment, in conjunction with suitable presentation of their results, could be used in place of the PIV testing apparatus.

Whereas traditional testing methodologies have determined an efficiency for a design, such as a turbine, they are not able to indicate the portion of the turbine that is introducing the inefficiencies.

The use of a PIV fluid flow testing apparatus provides a spatial velocity field representing the velocity of the fluid flow, either continuously or at a number of grid locations. The velocity field is generated by taking images of fluid flowing through the prototype. The fluid is seeded with particulate matter which flows through the prototype with the fluid. The position of the particulate matter is used to determine the spatial velocity field. This constitutes a series of measured velocities. The spatial velocity field shows changes in speed and direction of the fluid which can indicate the presence of flow irreversibilities.

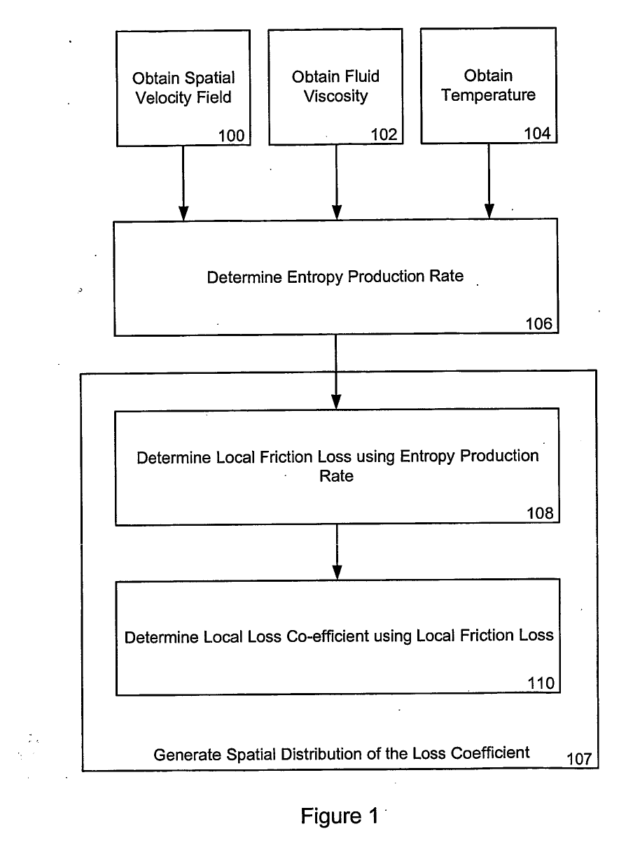

FIG. 1 illustrates a method of the present invention, where the spatial velocity field can be used to derive a local loss coefficient through the use of an entropy conversion. In steps 100, 102 and 104 the spatial velocity field, the fluid viscosity and the fluid temperature are obtained. Typically the spatial velocity field is obtained through the use of PIV testing, though as indicated above other methods can be used to create the spatial velocity field. The fluid viscosity is a function of both the fluid characteristics and the temperature of the fluid, and thus can be obtained in step 102 using standard computations or via measurement. The temperature of the fluid can be obtained in step 104 through a number of known techniques including the use of thermocouples and thermistors in the fluid flow. In one embodiment of the present invention, the temperature is assumed to be constant throughout the system, and thus constant viscosity is also assumed.

The obtained spatial velocity field and the viscosity and temperature profiles are then used to compute an entropy production rate in step 106. The entropy production rate defines how entropy is created in the system. As will be understood by those skilled in the art, entropy values in all portions of the system are positive, and additive. The determined entropy production rate is used to generate a spatial distribution of the loss coefficient in step 107. In a presently preferred embodiment of the present method of the invention, the generation of the spatial distribution of the loss coefficient in step 107 is performed through the determination of local friction loss in step 108, and the determination of local loss coefficients in step 110. More detail on how the various values can be determined is provided below.

To determine the local friction losses, in step 108, the entropy values are used in an additive fashion to determine local friction loss values, which are also referred to as head losses. The head loss is used in a final translation to a local loss coefficient in step 110, which is used to indicate the regions of a design candidate that are introducing unacceptable inefficiencies.

Entropy in a dynamic system is governed by the second law of thermodynamics, which in its transport form is expressed as

$$\frac{\partial ( ρ s )}{\partial t} + ∇ \cdot ( ρ vs + q ) = {\dot{P}}_{S} \qquad ( 1 )$$

where ρ represents the density of the fluid, s represents entropy, v represents the velocity of the fluid and q represents the Fourier Heat Flux. For irreversible processes such as heat transfer and viscous mixing, the Second Law requires that the entropy production rate P₃ is positive. The magnitude of local flow irreversibility is characterized by the rate of entropy production. This entropy production arises from the irreversible degradation of mechanical energy into internal energy through viscous dissipation, as well as heat transfer across a finite temperature difference. It can be shown that over a 2 dimensional spatial grid, used to simplify the analysis,

$${\dot{P}}_{s} = \frac{μ}{T} \{ {( \frac{\partial u}{\partial y} + \frac{\partial v}{\partial x} )}^{2} + 2 ( {( \frac{\partial u}{\partial x} )}^{2} + {( \frac{\partial v}{\partial y} )}^{2} ) \} + \frac{k}{{T}^{2}} \{ {( \frac{\partial T}{\partial x} )}^{2} + {( \frac{\partial T}{\partial y} )}^{2} \} \qquad ( 2 )$$

or in a discretised form:

$${\dot{P}}_{s} = \frac{μ}{T} {( \frac{u ( i , j + 1 ) - u ( i , j - 1 )}{Δ y} + \frac{v ( i + 1 , j ) - v ( i - 1 , j )}{Δ x} )}^{2} + 2 \frac{μ}{T} ( {( \frac{u ( i + 1 , j ) - u ( i - 1 , j )}{Δ x} )}^{2} + {( \frac{v ( i , j + 1 ) - v ( i , j - 1 )}{Δ y} )}^{2} ) \qquad ( 3 )$$

where \dot{P}ₛ, μ, u, v, T, Δx and Δy refer to entropy production rate, viscosity, x direction velocity, y direction velocity, temperature and grid spacings in the x and y directions, respectively. Either of these formulae can be used in step 106 of the present invention, though in many implementations the discretised version is easier to implement in digital systems. Both formulae (2) and (3) determine the entropy production rate using incremental spatial velocities and a ratio of viscosity and temperature profiles of the fluid flow. In equation (2) the incremental velocities are partial differentials, while in equation (3) they are true incremental values.

One skilled in the art will also appreciate that the determination of a head loss value in step 108 can be performed using the equation:
Hₗ=ΣT(d\dot{P}ₛ)/\dot{m} (4)
where H_{L} is the head loss, T and \dot{m} are the temperature and the mass flow. The head loss values are used to determine the local loss coefficient in step 110 using a readaption of:
H_{L}=KV²/2 g (5)
where V is the total velocity, which is the magnitude of the velocity vector at a speciefed point, and g is the acceleration due to gravity.

The determination of both head loss values and a local loss coefficient can be presented to a designer to indicate regions of flow irreversibility. This methodology, when applied provides insight into how the angles of two adjoining surfaces in a structure such as a turbine engine should be altered to reduce the entropy of the system. The above relationships between velocities, temperatures, viscosities and the entropy production rate can also be represented in other forms that can be shown to be equivalent using the known relationships between a variety of values in physics and mathematics.

Although discretization procedures for the conservation laws have been well documented, the discretization of the Second Law is less understood. The transport form of the Second Law is given by (1). For irreversible flow, such as viscous mixing in a recirculating flow, the Second Law requires that \dot{P}ₛ must remain positive. This equation can be rewritten in an equivalent form using the Gibbs equation and the thermal energy equation, and from this, it can be shown that the rate of entropy production can be written directly in terms of velocity and temperature. Using the Gibbs equation and thermal energy equation, it can be shown that (1) is equivalent to (2). This result remains consistent with the Second Law of thermodynamics in view of the positive definite terms. The right side of (2) represents a sum of squares, and thus the entropy production rate is positive for irreversible processes. The terms remain positive since mechanical energy is irreversibly converted to internal energy through viscous dissipation, and heat flows irreversibly down a temperature gradient through conduction (Fourier's Law). Both cases produce microscopic disorder (or entropy) in the fluid. Equations (1) and (2) provide alternatives for computing \dot{P}ₛ. The entropy transport equation is designated by (1), whereas the positive definite form is given in (2).

\dot{P}ₛ can be computed in (1) through spatial and temporal integration in an analogous manner to the Control-Volume-Based Finite Element Method (CVFEM) approach for the conservation laws. The absolute entropy can be evaluated in terms of temperature through the Gibbs equation. On the other hand, \dot{P}ₛ is evaluated in (3) by discrete values of velocity and temperature obtained experimentally. The sources of entropy generation are clearly identified in equation (2). The first term represents entropy generation due to heat transfer across the control surface as a result of temperature gradients in the fluid, whereas the second term represents the local entropy generation due to viscous dissipation. A positive definite form applies to both compressible and incompressible Newtonian fluids in laminar or turbulent flows. The positive-definite equation is better suited for the predictions of local entropy generation in the optimization of engineering systems. For an isothermal process, it isolates the effect of the heat transfer contribution on entropy generation. The resulting form of the entropy generation equation representing the viscous dissipation contribution to loss is given by the first term in the right hand side of (2). In the context of steady, isothermal internal flows, this term is directly related to the mechanical power needed to move the flow through a duct.

As noted above, unlike velocity or temperature, the measurement of entropy cannot be performed directly. However, either Gibbs equation or (2) can be used as an indirect method of characterizing the flow irreversibility. For example, the entropy produced by friction irreversibility can be estimated by measured gradients of velocity through (2). In an embodiment of the present invention, these flow gradients are obtained by post-processing the velocity distribution measured experimentally using the PIV. As a result, the rate of entropy generation can be considered as a derived experimental quantity.

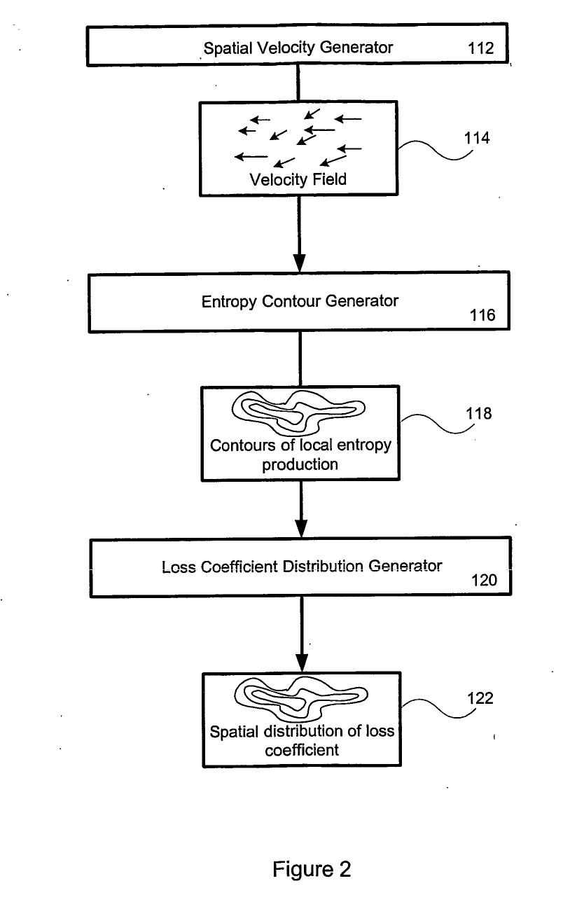

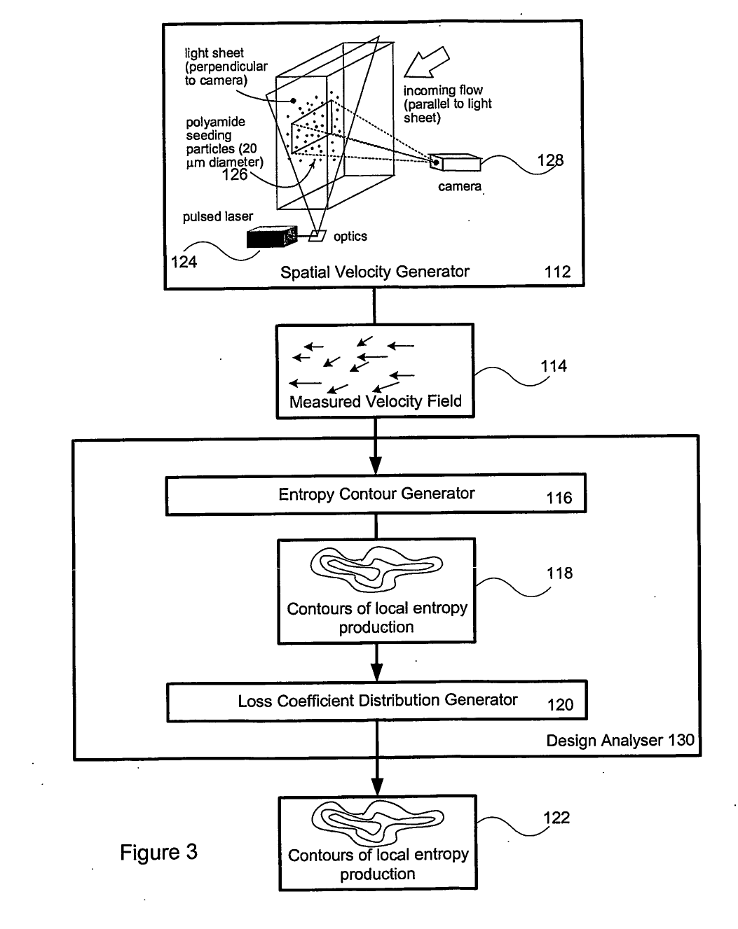

FIG. 2 illustrates a system of the present invention. A spatial velocity generator 112 is used to determine a spatial velocity field 114 for fluid flow through or around the design. The operation of an embodiment of the spatial velocity generator will be described in relation to FIG. 3 below. The velocity field 114 is used as an input to the entropy contour generator 116. The entropy contour generator 116 uses the velocity field 114 to generate a contour map of the local entropy production 118. Generator 116 typically employs equations (2) or (3) to generate the contours of entropy production 118, depending upon whether the representation of the velocity field 114 provided by the spatial velocity generator 112 is continuous or discrete. The contours of the local entropy production 118 are provided to the loss coefficient distribution generator 120. Generator 120 uses contour map 118 to generate the spatial distribution of the loss coefficient 122. In a presently preferred embodiment of the system, the spatial distribution of the loss coefficient is either presented in a manner that allows a designer to readily identify the location of entropy producing elements, or is further analysed to indicate to a designer the location of flow irreversibilities.

FIG. 3 illustrates an embodiment of the present invention, wherein the spatial velocity generator 112 employs a PIV tester to determine the spatial velocity field 114. PIV is a widely used technique for measuring the spatial distribution of velocity in a flow field. In the current study, seeded particles 126 are illuminated by a pulsed laser 124 along a plane sheet perpendicular to a camera 128. Images of the particles are captured in successive frames. The results of the two sets of images represent the location of the group of particles at two instants in time. The PIV software uses these successive images to quantify the distance of particle group motion between images. With the quantified distances, and the time between images known, the PIV software can calculate the velocity of the seed particles 126. These particle velocities are considered to represent the fluid velocity, which is represented by the measured spatial velocity field 114. The particle velocities are used to generate discrete measured spatial velocity field 114. The measured velocity field is provided to design analyzer 130, which incorporates both the entropy contour generator 116 and the loss coefficient distribution generator 120 as software elements on a common computing platform. The computing platform could be replaced with either firmware running on hardware circuitry, or hardwired circuitry designed specifically for this application. The spatial distribution of the loss coefficient 122 is then either presented to a designer, or can be used by the design analyzer 130 to alter the design to reduce entropy production.

It should be noted that the spatial velocity generator 122 can be implemented as a software simulation of a model undergoing fluid flow testing. In this case, with proper understanding of how fluid flow is modelled, the design analyser 130 can use the spatial distribution of the loss coefficient to modify the model. This then would form the basis for an iterative design tool.

The above-described embodiments of the present invention are intended to be examples only. Alterations, modifications and variations may be effected to the particular embodiments by those of skill in the art without departing from the scope of the invention, which is defined solely by the claims appended hereto.

1. A method of detecting flow irreversibility in a fluid flow having a predetermined spatial velocity field representing the spatial distribution of velocities in a fluid flow, the method comprising:
determining an entropy production rate representing the spatial distribution of entropy production in the fluid flow in accordance with incremental spatial velocities determined from the spatial velocity field and a ratio of viscosity and temperature profiles of the fluid flow;
generating a spatial distribution of a loss coefficient, representing the spatial distribution of inefficiencies arising from flow irreversibility in the fluid flow, in accordance with the temperature profile and the determined entropy production rate; and
analysing the spatial distribution of the loss coefficient to identify a flow irreversibility.

2. The method of claim 1, wherein the spatial velocity field is a set of discrete values, and the resulting entropy production rate and spatial distribution of the loss coefficient are discrete valued functions.

3. The method of claim 2, wherein the resulting entropy production rate relates fluid viscosity, velocity of the fluid in each of two directions, temperature of the fluid, and spacing of grid elements in one of the spatial velocity field, the fluid viscosity profile and the temperature profile.

4. The method of claim 1, wherein the viscosity profile and the temperature profile are constant valued.

5. The method of claim 1, wherein the step of generating the spatial distribution of the loss coefficient further includes:
determining a head loss value relating the temperature profile, mass flow in the fluid flow and the entropy production rate, the head loss value representing local friction loss; and
determining a local loss coefficient relating the head loss value, total velocity of the fluid and acceleration due to gravity, the local loss co-efficient representing the loss coefficient in a defined region of the fluid flow.

6. A flow irreversibility detector, for detecting a flow irreversibility in a fluid flow having a predetermined spatial velocity field representing spatial distribution of velocities in the fluid flow, the flow irreversibility detector comprising:
an entropy contour generator, for receiving the spatial velocity field, and for generating an entropy production contour representing adjoining regions with similar entropy production rates in accordance with a ratio of a fluid viscosity profile and a fluid temperature profile and the incremental spatial velocities from the predetermined spatial velocity field;
a loss coefficient distribution generator for receiving from the entropy contour generator the entropy production contour and for generating, a spatial distribution of a loss coefficient representing the spatial distribution of inefficiencies arising from flow irreversibility in the fluid flow, in accordance with the temperature profile and the entropy contour; and
an irreversibility identifier for detecting regions of flow irreversibility by analysing the spatial distribution of the loss coefficient.

7. The detector of claim 6, wherein the spatial velocity field is generated by a particle image velocimetry system.

8. The detector of claim 6, further including a design analyser for modifying a design of a structure to reduce the loss coefficient in detected regions of flow irreversibility.

9. The detector of claim 6, wherein the spatial velocity field is generated by a design modelling tool for simulating fluid flow in a design.

10. The detector of claim 8, further including a design analyser for modifying the design to reduce the loss coefficient in detected regions of flow irreversibility.
